(19) United States
(12) Patent Application Publication
(10) Pub. No.: US 2005/0107498 A1
(43) Pub. Date: May 19, 2005

(54) Rapidly soluble film covering based on polyvinylalcohol-polyether graft copolymers combined with components containing hydroxyl, amide, or ester functions

(76) Inventors: Karl Kolter, Limburgerhof (DE); Maximilian Angel, Schifferstadt (DE)

Correspondence Address: NOVAK DRUCE DELUCA & QUIGG, LLP, 1300 EYE STREET NW, SUITE 400 EAST, WASHINGTON, DC, 20036, US

(21) Appl. No.: 10/501,773

(22) PCT Filed: Feb. 4, 2003
(86) PCT No.: PCT/EP03/01056

(30) Foreign Application Priority Data
Feb. 21, 2002 (DE) 10207 427.5

(51) Int. Cl. C08K 5/15; C08K 3/34; C08K 3/00

(52) U.S. Cl. 524/35; 524/56; 524/492; 524/557

(57) ABSTRACT

A quick dissolving film coating composition for coating solid substrates is composed of a) 10-90% by weight of a polyvinyl alcohol-polyether graft copolymer (component A), b) 5-80% by weight of at least one further component containing at least one functional group selected from the group consisting of hydroxyl, amide and ester functions (component B), and c) 0-70% by weight of further customary coating constituents (components C).

The present invention relates to quick dissolving film coatings for coating solid substrates such as pharmaceutical, cosmetic or agrochemical product forms, seed, dietary supplements, and foods, said coatings being composed of at least one polyvinyl alcohol-polyether graft copolymer (component A), at least one component containing hydroxyl, amide or ester functions (component B), and, optionally, further customary coating constituents (components C). The invention further relates to processes for producing dry coating premixes and aqueous coating solutions and suspensions, and applying them to solid product forms.

Solid product forms are provided with a quick dissolving coating for any of a host of different reasons. By so coating them it is possible, for example, to improve the appearance, distinctiveness, and swallowability, to mask a bitter taste, or to protect the product form against external influences such as humidity or oxygen, for example. Since the film coating is intended to dissolve rapidly in various aqueous media and also in synthetic gastric fluid and intestinal fluid, the prime constituent of the coating preparation must be a water soluble film forming polymer. Film forming polymers used for coating tablets include primarily hydroxypropylmethylcellulose and hydroxypropylcellulose, but these have serious disadvantages. First, the viscosity of these polymers in water is very high and permits a concentration of only up to about 10%, since at higher concentrations the high viscosity no longer permits fine atomization in the spray nozzle, and the coating becomes rough, inhomogeneous, and unattractive. Secondly, these polymers are very brittle and frequently suffer cracks during storage, especially when the core changes in volume due to absorption or release of moisture.

Polyvinyl alcohol is another known film former, but is seldom used owing to a variety of disadvantages. The use of polyvinyl alcohol preparations further including plasticizer and talc is described in WO 01/04195. Disadvantageous features of these preparations include their slow dissolving during preparation of the aqueous coating solution, high viscosity, low concentration in the spraying solution, the use of plasticizers, and the slow dissolution rate of the film coating, particularly after storage, and also the embrittlement of the film coating after storage, which is accompanied by instances of cracking.

The use of polyvinyl alcohol-polyether graft copolymers as coating agents or binders in pharmaceutical product forms or as packaging material or else as additives to cosmetic, dermatological or hygiene preparations is known, for example, from WO 00/18375. Described by way of example is a formula for a film coating composition which is composed of a polyvinyl alcohol-polyether graft copolymer and the customary coating constituents for coloring and covering, namely iron oxide, talc, and titanium dioxide. Although flexible, a coating of this kind is relatively soft and shows signs of abrasion if acted on by shear forces. This is particularly significant in the case of very large coating batches, since in that case the high pressure occasioned by the charge size of the tablets in conjunction with the rolling movement of the tablets in the drum generates correspondingly high shear forces. Since many drugs and some excipients as well are very lipophilic, adhesion of the coatings to the tablet surface is frequently poor. Moreover, the smoothness and shine of such coating preparations are unsatisfactory.

It is an object of the present invention to develop a film coating which can be dissolved or suspended very quickly and easily in water, resulting in a very short preparation time for the spraying formulation, which can be sprayed at a high rate and in high polymer and solids concentrations without blockage of the spraying nozzle, which spreads very well on the surface, which is flexible and exhibits no cracking whatsoever during storage, which is nontacky, which adheres well to all surfaces, exhibits excellent smoothness and shine, which is very stable with respect to mechanical loading, and which dissolves very quickly.

The film coating compositions of the invention are composed of:
a) 10-90% by weight, preferably 20-80% by weight, of polyvinyl alcohol-polyether graft copolymers (components A)
b) 5-80% by weight, preferably 10-70% by weight, of auxiliaries containing hydroxyl, amide or ester function
c) and 0-70%, preferably 5-60%, of further customary adjuvants for film coatings.

By polyvinyl alcohol-polyether graft copolymers are meant polymers obtainable by polymerizing
a) at least one vinyl ester of aliphatic C₁-C₂₄ carboxylic acids, preferably vinyl acetate, in the presence of
b) polyethers of the formula I
   R¹—O—(R²—O)ₓ—(R³—O)_{y}—(R⁴—O)_{z}—R⁵ I
c) in which the variables independently of one another have the following meanings:
   R¹ is hydrogen, C₁-C₂₄ alkyl, R⁶—C(═O)—, polyalcohol residue;
      preferably R₁ is H or CH₃
   R⁵ is hydrogen, C₁-C₂₄ alkyl, R⁶—C(═O)—;
      preferably R⁵ is H
   R² to R⁴
      are —(CH₂)₂—, —(CH₂)₃—, —(CH₂)₄—, —CH₂—CH(CH₃)—, —CH₂—CH(CH₂—CH₃)—, —CH₂—CHOR⁷—CH₂—;
      preferably R₂ to R₄ are —(CH₂)₂—, —CH₂—CH(CH₃)— with very particular preference R² to R⁴ are —(CH₂)₂—
   R₆ is C₁-C₂₄ alkyl;
   R₇ is hydrogen, C₁-C₂₄ alkyl or R⁶⁻C(═O)—;
   x is from 1 to 5 000;
      preferably x is from 10 to 2 000;
      with very particular preference x is from 20 to 500
   y is from 0 to 5 000;
      preferably y is 0
   z is from 0 to 5 000;
      preferably z is 0,
   with the proviso that x>10 if y and z=0,
      and subsequently hydrolyzing some or all of the polyvinyl ester groups.
   x, y, z:
      the calculation of the molecular weight of the polyether from x, y, and z gives an average value, since such products normally possess a broad distribution of molar weight.

Preference is given to polyethers having an average molar weight of between 400 and 50 000 g/mol, with particular preference from 1 500 to 20 000 g/mol.

The preparation of such graft copolymers is conventional.

DE 1 077 430 describes a process for preparing graft polymers of vinyl esters on polyalkylene glycols.

DE 1 094 457 and DE 1 081 229 describe processes for preparing graft polymers of polyvinyl alcohol on polyalkylene glycols by hydrolyzing the vinyl esters, and their use as protective colloids, water soluble packaging films, as sizes and finishes for textiles, and in cosmetology.

Preference is given to polymers having a degree of hydrolysis of the
polyvinyl ester groups of >70 mol %,
with particular preference >80 mol %, and
with very particular preference >85 mol %.

Particular preference is given to a polyvinyl alcohol-polyether graft copolymer in which
a) vinyl acetate was used as the monomer to be grafted,
b) the variables have the following meanings:
   R¹=H
   R²-R⁴=—(CH₂)₂—
   R₅=H
   x=from 20 to 500
   y=0
   z=0
   and thus represent a polyethylene glycol having an average molecular weight of from 6 000
c) the degree of hydrolysis of the ester groups is >85 mol %, and
d) the mass-ratio of the polyvinyl alcohol moieties to the polyethylene glycol 6000 moieties is 75:25.

The film coating compositions further comprise as components B components which contain at least one functional group selected from the group consisting of hydroxyl, amide and ester functions. Both polymers and low molecular mass organic compounds can be used as components B. In accordance with the invention, low molecular mass means that the organic compound in question has up to 20 carbon atoms.

These products are generally water soluble, which for the purposes of this invention means that ≧1 g dissolve at 25° C. in 100 ml of water. Water soluble may also mean that the products dissolve as a function of pH. Preferably, more than 5 g dissolve in 100 ml; with particular preference, more than 20 g dissolve in 100 ml. However, the products may also be water swellable.

Polymers containing hydroxyl, amide or ester functions that are used include:
polyvinyl alcohols, polysaccharides, celluloses, starches, polylactides, polyethylene glycols, polypropylene glycols or polyethylene glycol-polypropylene glycol block copolymers, including their derivatives;
polyvinylpyrrolidones, vinylpyrrolidone-vinyl acetate copolymers;
vinylpyrrolidone-methacrylate copolymers, vinylpyrrolidone-acrylate copolymers;
(meth)acrylate copolymers, hydroxyalkyl (meth)acrylate copolymers as described, for example, in DE 10049297, polyvinyl acetates; and
gelatin.

Preferred compounds are:
water soluble polymers such as polyvinyl alcohols having a degree of hydrolysis of 80-99%, 6:4 vinylpyrrolidone-vinyl acetate copolymer (copolyvidone), polyvinylpyrrolidones having a K value of 12-90, hydroxypropylmethylcellulose, hydroxypropylcellulose, hydroxyethylcellulose, hydroxyethylmethylcellulose,
methylcellulose, sodium carboxymethylcellulose, amylose, maltodextrins, glucose syrups, cyclodextrins, dextrans, inulin, polyfructose, polydextrose, alginates, including propylene glycol alginates, pectins, carrageenans, guar, tara, xanthans, and gum arabic,
polymers which dissolve as a function of pH, such as 1:2:1 butyl methacrylate-2-dimethylaminoethyl methacrylate-methyl methacrylate copolymer, 1:1 methacrylic acid-ethyl acrylate copolymer, and chitosans, including their water soluble salts,
water swellable polymers such as ethylcellulose, crosslinked polyvinylpyrrolidone, polyvinyl acetate, and cellulose, especially microcrystalline cellulose.

Low molecular mass organic compounds used include:
sugar, sugar alcohols or derivatives thereof; urea.

Preferred compounds are:
lactose, sucrose, glucose, xylose, mannitol, sorbitol, xylitol, isomalt (Palatinit®).

As component B it is also possible to use highly disperse silica having a specific surface area ≧100 m²/g.

The film coatings may further comprise as components C additional auxiliaries such as are customary coating constituents. Further customary coating constituents include:

Coloring components:
color pigments and dyes in water soluble or water insoluble form, e.g., quinoline yellow lake, tartrazine lake, yellow orange lake, FD&C yellow aluminum lake, cochenille red lake, erythrosine lake, azorubine lake, indigotine lake, erythrosine, brillant black, patent blue, brilliant blue, cochenille red, yellow orange, amaranth, FD&C blue No. 1, indigotine, beta-carotene
white pigments for increasing the hiding power of the coating, e.g., titanium dioxide, talc; color pigments such as iron oxides, for example
detackifiers, e.g:, talc, magnesium stearate, glycerol monostearate
fillers such as calcium hydrogen phosphates, for example
foam inhibitors or destroyers such as silicone, simethicone, octanol, for example
shine enhancers, e.g., waxes, fatty alcohol derivatives or fatty acid derivatives, polyethylene glycols
surfactants for improving the wetting behavior and spreading, e.g., sodium lauryl sulfate, sorbitan fatty acid esters or ethoxylated sorbitan fatty acid esters, ethoxylated esters of hydrogenated castor oil or ethoxylated fatty acid esters such as polyoxyethylene glycerol ricinolate-35 or polyoxyethylene glycerol trihydroxystearate-40, sodium dioctyl sulfosuccinate
pH regulators and buffers such as sodium citrate, citric acid, phosphate buffers, acetate buffers, for example
plasticizers
protective colloids.

The combinations according to the invention produce unenvisaged and surprising product properties and film properties.

Where, for example, the polyvinyl alcohol-polyether graft copolymers of the invention are combined with polyvinyl alcohols, synergistic effects are found in as much as at certain proportions the elongation at break, which characterizes the flexibility of the films, is higher than that of the individual components. This phenomenon occurs not only at moderate and high humidities such as, for example, 54% RH (relative humidity) but also at low humidities such as, for example, 11% RH. Another unforeseeable was that the flexibility of the preparations of the invention is constant even on storage. Indeed, polyvinyl alcohol is known for its dramatic embrittlement over time and drop in flexibility to virtually zero. Apparently, the polyvinyl alcohol molecules become ordered in a particular way during storage to produce a kind of crystalline state which is of low flexibility and fractures easily. As a result of the combination with polyvinyl alcohol-polyether graft copolymers, this structure is broken and the films retain their flexibility even on storage.

| | | Elongation at | |
|---|---|---|---|
| | | break at | Tack |
| Parts by weight | | 23°/54% RH [%] | at 30°/75% RH |
| PVA-PEG graft copolymer | | 102 | 1.25 |
| PVA-PEG graft copolymer | 80 | 169 | 1 |
| Polyvinyl alcohol | 20 | | |
| PVA-PEG graft copolymer | 60 | 213 | 0.75 |
| Polyvinyl alcohol | 40 | | |
| PVA-PEG graft copolymer | 40 | 195 | 0.50 |
| Polyvinyl alcohol | 60 | | |
| PVA-PEG graft copolymer | 20 | 167 | 0.75 |
| Polyvinyl alcohol | 80 | | |
| Polyvinyl alcohol | | 160 | 1 |

PVA-PEG graft copolymer: Polyvinyl alcohol-polyethylene glycol 6000 (75:25), degree of hydrolysis 94 mol % (polyethylene glycol 6000 means that a polyethylene glycol having an average molecular weight of 6 000 was used as polyether b) of the formula I).
Polyvinyl alcohol: Degree of hydrolysis 88 mol %, viscosity 4 mPas (of a 4% strength solution at 20° C., DIN 53015)

| | | | | Elongation |
|---|---|---|---|---|
| | | | Elongation | at break |
| | | Elongation | at break | after |
| | | at break | after storage | storage |
| | | after | at 23° C. for | at 23° C. for |
| | | preparation | 6 months | 12 months |
| Parts by weight | | [%] | [%] | [%] |
| PVA-PEG graft | 60 | 213 | 205 | 202 |
| copolymer | | | | |
| Polyvinyl alcohol | 40 | | | |
| Polyvinyl alcohol | | 160 | 30 | 5 |

PVA-PEG graft copolymer: Polyvinyl alcohol-polyethylene glycol 6000 (75:25), degree of hydrolysis 94 mol %
Polyvinyl alcohol: Degree of hydrolysis 88 mol %, viscosity 4 mPas.

A similar picture with a synergistic effect is found with the tack as well, since certain combinations exhibit lower tack than the individual components. The tack was determined by the method of Hoessel (Cosmetics and Toiletries 111(8), 73 ff. (1996)), a figure of 5 describing high tack and a figure of 0 no tack. The lower the figure, the lower the tack.

When the polyvinyl alcohol-polyether graft copolymers of the invention are combined with polyvinylpyrrolidone-polyvinyl acetate copolymers, similar particularities arise. Here again the extensibility of the combinations is higher than that of the individual components or higher than the sum of the proportionate values. This is all the more surprising since copolyvidone alone is very brittle and inextensible.

| | | Elongation at break |
|---|---|---|
| Parts by weight | | at 23°/54% RH [%] |
| PVA-PEG graft copolymer | | 99 |
| PVA-PEG graft copolymer | 7.5 | 114 |
| Copolyvidone | 2.5 | |
| PVA-PEG graft copolymer | 6 | 119 |
| Copolyvidone | 4 | |
| PVA-PEG graft copolymer | 5 | 137 |
| Copolyvidone | 5 | |
| PVA-PEG graft copolymer | 3 | 40 |
| Copolyvidone | 7 | |
| Copolyvidone | 0 | |

PVA-PEG graft copolymer: Polyvinyl alcohol-polyethylene glycol 6000 (75:25), degree of hydrolysis 94 mol %
Copolyvidone: 6:4 polyvinylpyrrolidone-polyvinyl acetate copolymer

Polyvinyl alcohol-polyether graft copolymers are generally relatively soft polymers, and for a variety of end uses harder coatings are advantageous. The combinations according to the invention lead to considerably increased tensile strengths and moduli of elasticity, but are nevertheless flexible. This effect is exhibited not only by polymers but also by low molecular mass substances such as sugars, sugar alcohols, glucose syrups or maltodextrins. It is also generally known that solids incorporated into film coatings weaken them. Surprisingly, in the case of polyvinyl alcohol-polyether graft copolymers, the opposite effect is found. The strength increases, as is evident from the examples with microcrystalline cellulose and highly disperse silica.

| | | Tensile strength at |
|---|---|---|
| Parts by weight | | 23° C./54% RH [N/mm²] |
| PVA-PEG graft copolymer | | 9 |
| PVA-PEG graft copolymer | 5 | 12 |
| Copolyvidone | 5 | |
| PVA-PEG graft copolymer | 8 | 14 |
| Mannitol | 2 | |
| PVA-PEG graft copolymer | 8 | 17 |
| Microcrystalline cellulose | 2 | |
| PVA-PEG graft copolymer | 8 | 12 |
| Maltodextrin DE 17 | 2 | |
| PVA-PEG graft copolymer | 6 | 24 |
| Polyvinyl alcohol | 4 | |
| PVA-PEG graft copolymer | 8 | 19 |
| Carrageenan | 2 | |
| PVA-PEG graft copolymer | 8 | 20 |
| Highly disperse silica | 2 | |
| PVA-PEG graft copolymer | 8 | 26 |
| Chitosan HCl | 2 | |
| PVA-PEG graft copolymer | 8 | 12 |
| Alginate | 2 | |
| PVA-PEG graft copolymer | 8 | 13 |
| Poloxamer 188 | 2 | |
| PVA-PEG graft copolymer | 8 | 14 |
| Gelatin 100 bloom | 2 | |

PVA-PEG graft copolymer: Polyvinyl alcohol-polyethylene glycol 6000 (75:25), degree of hydrolysis 94 mol %
Tensile strength measurement: on 100 μm thick polymer films (cast from aqueous solution)

In many cases the claimed combinations lead, surprisingly, to reduced viscosity of the spraying solution for a given solids content. As a result, atomization is improved, the danger of nozzle blockage and caking on the spraying nozzle is reduced, the spreading of the spraying solution on the tablet surface is enhanced, and the film coating is more uniform, smoother and shinier. The spraying rate can be increased markedly. Moreover, the solids content of the spraying formulation can be further increased, so making the whole process quicker and more cost effective. Spraying suspensions with solids contents up to 50% by eight can be applied.

| | | Viscosity of a 20% |
|---|---|---|
| Parts by weight | | strength solution [mPas] |
| PVA-PEG graft copolymer | | 95 |
| PVA-PEG graft copolymer | 5 | 60 |
| Copolyvidone | 5 | |
| PVA-PEG graft copolymer | 8 | 65 |
| Microcrystalline cellulose | 2 | |
| PVA-PEG graft copolymer | 8 | 61 |
| Maltodextrin DE 17 | 2 | |
| PVA-PEG graft copolymer | 8 | 76 |
| Poloxamer 188 | 2 | |
| PVA-PEG graft copolymer | 8 | 69 |
| Urea | 2 | |
| PVA-PEG graft copolymer | 8 | 69 |
| Isomalt | 2 | |
| PVA-PEG graft copolymer | 8 | 58 |
| Lactose | 2 | |

PVA-PEG graft copolymer: Polyvinyl alcohol-polyethylene glycol 6000 (75:25), degree of hydrolysis 94 mol %

The coating preparations of the invention adhere better to the product forms that are to be coated. This makes it possible in particular to coat very lipophilic surfaces, such as tablets, containing relatively high proportions of lipophilic active ingredients, wax or fats. Customary coating preparations fail in this respect, since the coating solution spreads poorly and adheres poorly.

The excellent wetting properties are also evident in the outstanding color homogeneity of the coating. Even with thin coatings and at high solids concentrations there are none of the “nests” of color attributable to a local high colorant concentration.

The film coatings are smooth and shiny even with a very high pigment and/or solids fraction. The engraving is beautifully reproduced. There are no instances of bridging or accumulation of solids in the engraving. The coated product forms possess an outstanding appearance.

The oxygen permeability of the preparations of the invention is low, thereby enabling better protection for oxygen sensitive active substances in the core. As a result of reduced oxidative degradation, moreover, the stability of the dyes used is increased.

It should be stressed again at this point that the preparations of the invention do not require any plasticizer at all. Freedom from plasticizer is a massive advantage, since plasticizers often lead to problems during the storage of coated forms.

For instance, the plasticizer may migrate into the core and alter the physical and chemical properties of the active substance, causing the film to become brittle and to tend toward cracking. The majority of plasticizers, moreover, possess a certain degree of volatility, which again leads to embrittlement. All of these disadvantages are absent from the coatings of the invention.

The coating preparations of the invention may be prepared in a variety of ways.
1. In preparing the spraying solution the individual components are introduced in succession into water with stirring, the order being variable. Normally, the insoluble coating constituents (pigments, covering agents) are added only after the solubles have dissolved. However, the preparations of the invention may also be added directly in succession, without waiting for the soluble constituents to dissolve. The disadvantage in this case is that a large number of individual weighing steps are needed for each spray batch. Customary coating preparations require a step of deagglomeration or homogenization by means of an Ultra-Turrax, high-pressure homogenizer or corundum disk mill. With the coating preparations of the invention this time consuming process step is generally no longer necessary. Excellent homogeneity and dispersibility of the preparation are brought about just by simple stirring. The polyvinyl alcohol-polyether graft copolymers surprisingly accelerate the dissolution of the auxiliaries with hydroxyl, amide or ester structure and ensure rapid and homogeneous dispersing of the solids that are used.
2. But it is also possible to dry mix the individual components to produce what is known as a premix, requiring only one weighing step for the user. Alternatively, the premix may also be prepared by a variety of granulation methods such as dry granulation, compacting, wet granulation, fluidized bed granulation or melt granulation, for example. These products have excellent redispersibility, again without the use of high shear machines. Redispersing is effected by stirring the entire preparation into water, using a conventional stirrer. The dissolution and redispersing time is even shorter than under 1.
3. By means of a drying process such as spray drying, roller drying or fluidized bed drying, for example, first of all a homogeneous powder or granules are produced from an aqueous solution or dispersion of polyvinyl alcohol-polyether graft copolymer and the auxiliaries containing hydroxyl, amide or ester function. Said powder or granules may be processed further either by method 1 or by method 2. Particularly advantageous in this context is the preparation of a premix by dry mixing with the other coating constituents, since this premix requires only an extremely short time for redispersing.
4. A drying process as in 3. is used to convert all of the ingredients except for the color pigment into a powder or granules (white premix) which possesses outstanding redispersibility and shows no separation tendencies whatsoever. The color pigment can be incorporated by dry admixing or by the methods specified under 2. Alternatively, the color pigment may not be stirred into the spraying suspension, together with the white premix, until during the preparation of said suspension.
5. A dry mixing method or a granulation method as in 2. is used to convert all of the ingredients except for the color pigment into a powder or granules (white premix) which possesses very good redispersibility and stability on storage. The color pigment may be stirred in together with the white premix only during the preparation of the spraying suspension, or may be stirred in separately before or after the white premix. This makes it possible for users to formulate their own different colors. The excellent wetting properties of the white premix ensure uniform color distribution.

The time required for the preparation of the spraying suspension is shorter by method 2 than by method 1 and in general is shorter by methods 3 and 4 than by method 2. The more intimate the combination of polyvinyl alcohol-polyether graft copolymer and the auxiliaries containing hydroxyl, amide or ester function, the quicker the dissolution of these products. Accordingly, a powder prepared from polyvinyl alcohol-polyether graft copolymer and the auxiliaries containing hydroxyl, amide or ester function by spray drying dissolves more rapidly than the dry mixture. The best example of this is the combination with polyvinyl alcohol. Polyvinyl alcohol alone requires several days in water at room temperature until fully dissolved. A product prepared by joint spray drying dissolves within minutes.

The premixes of the combinations according to the invention possess, generally, the advantage that they do not form lumps when added to and stirred into water and that they exhibit excellent pigment distribution and homogeneity. The premixes may be added to the initial water charge at a relatively quick rate. The spraying suspension can therefore be prepared more quickly, more simply, and using simple stirring tools. High speed stirrers with high shearing stress, which additionally incorporate air into the spraying suspension and cause foam, are unnecessary. Where appropriate, solid or liquid defoamers may also be used.

The preparation of what are known as white premixes, containing all of the constituents except for the dye, allows the user to formulate different colors when preparing the spraying suspension, by adding the respective dyes. A white premix can therefore be used for all coatings, so producing enormous cost advantages.

It is of course clear that the white premix can be used without further additions in order to produce white film coatings.

Furthermore, the coatings of the invention may also be used for colorless, transparent coatings. In this case the use of water insoluble constituents, especially the covering agents, is not practiced. The flexibility of such transparent coatings, composed predominantly of the polyvinyl alcohol-polyether graft copolymer and at least one water soluble auxiliary containing hydroxyl, amide or ester function, makes them particularly suitable for the coating of deformable product forms, such as capsules. However, they may also be applied as a so-called topcoat to an existing coating film, so increasing smoothness and shine.

Dissolution time for preparing a 20% strength by weight aqueous solution at room temperature using a paddle stirrer at 900 revolutions/min.

| Parts by weight | | Dissolution time |
|---|---|---|
| Polyvinyl alcohol | | 48 h* |
| Degree of hydrolysis | 88 mol % | |
| Viscosity | 4 mPas | |
| PVA-PEG graft copolymer | | 10 min |
| PVA-PEG graft copolymer | 8 | 7 min |
| Lactose | 2 | |
| Dry mixture | | |
| PVA-PEG graft copolymer | 5 | 11 min |
| Polyvinyl alcohol | 5 | |
| Spray dried product | | |
| PVA-PEG graft copolymer | 5 | 6 min |
| Copolyvidone | 5 | |
| Dry mixture | | |
| PVA-PEG graft copolymer | 5 | 5 min |
| Copolyvidone | 5 | |
| Spray dried product | | |
| PVA-PEG graft copolymer | 5 | 4 min |
| Microcrystalline cellulose | 5 | |
| Dry mixture | | |
| PVA-PEG graft copolymer | 5 | 7 min |
| Mannitol | 5 | |
| Granules | | |

*after 48 h, there is still an undissolved fraction of about 3%
PVA-PEG graft copolymer: Polyvinyl alcohol-polyethylene glycol 6000 (75:25), degree of hydrolysis 94 mol %

The film coating may be applied in any coating means suitable for solid pharmaceutical, cosmetic, and agrochemical product forms, seed, dietary supplements, and foods, such as, for example, horizontal drum coaters, fluidized bed coaters, dip coaters, and coating pans.

For the atomization of the coating preparation it is preferred to use a two-fluid nozzle. The incoming air temperature should be between 30-90° C., preferably between 40-80° C.

In principle it is possible to coat all forms of core with domed, convex or concave surface, irrespective of whether the forms are circular, polygonal, oblong or football shaped.

As a result of the low viscosities and excellent wetting and spreading properties, an unparalleled lining of the engraving is achieved. No bridge effects or smear effects occur in the engraving.

The core may also carry a subcoating, which is generally applied in order to provide particular protection to the active substance—protection, for example, against water, oxygen, protons or chemicals in the coating, and also the contents of the stomach and gut.

The coatings of the invention may also be applied in two or more layers which differ in their composition. For example, a layer of a colorless coating may be applied over a colored coating.

As far as the active substances are concerned, there are no restrictions for the product forms of the invention. Active substances of all areas of indication can be used, both human and veterinary drugs, vitamins, carotenoids, nutraceuticals, dietary supplements, minerals, micronutrients, etc. The active substances may differ in their physicochemical properties such as lipophilicity, solubility, particle size, particle structure, surface area, etc.

The product forms to be coated may be in the form of tablets, capsules, extrudates, pellets, granules, crystals, powders, seed or food forms.

The combination of polyvinyl alcohol-polyether graft copolymers with auxiliaries which carry one or more hydroxyl, amide or ester functions leads surprisingly to considerably enhanced coating properties.

The film coating mixtures of the invention can be dissolved or dispersed very simply and rapidly in water, possess low viscosities, extremely high flexibilities, good strengths, low tack, and can be applied to solid product forms at a high spraying rate in high solids concentration. The coated product forms are very smooth, shiny, uniformly colored, disintegrate very rapidly, and are stable on storage.

### EXAMPLES

Unless otherwise indicated, percentages are by weight.

### Example 1

Coating Composition:

| | |
|---|---|
| 75:25 polyvinyl alcohol-polyethylene | 35% |
| glycol 6000 graft copolymer (degree of | |
| hydrolysis: 94 mol %) | |
| 6:4 vinylpyrrolidone-vinyl acetate | 35% |
| copolymer | |
| (copolyvidone) | |
| Talc | 20% |
| Titanium dioxide | 5% |
| Red iron oxide | 5% |

Preparation:

All of the constituents were stirred into water in the order indicated above, one directly after the other, using a paddle stirrer, so giving a spraying formulation having a solids content of 30%. Dissolution or dispersing was over after 17 minutes. The spraying suspension was of low viscosity and homogeneous.

The spraying suspension was applied in a horizontal drum coater (24″ Accela-Cota) to 5 kg of propranolol tablets of the following composition:

| | |
|---|---|
| Propranolol-HCl | 40 mg |
| Ludipress ® (BASF AG)¹⁾ | 97.5 mg |
| Copolyvidone | 12.5 mg |
| Microcrystalline cellulose²⁾ | 97.5 mg |
| Magnesium stearate | 2.5 mg |
| Total weight | 250 mg |

Diameter: 9 mm, domed
¹⁾ Formulated product of 93% by weight lactose, 3.5% by weight povidone and 3.5% by weight crospovidone
²⁾ Average particle size: 100 μm

Spraying Conditions:

| | |
|---|---|
| Incoming air temperature | 70° C. |
| Outgoing air temperature | 38° C. |
| Spraying rate | 50 g/min |
| Spraying pressure | 4 bar |
| Application rate | 634 g of spray dispersion, i.e., |
| | 190 g of solids |
| Spraying time | 13 min |

Properties of Film Coated Tablets:

| | |
|---|---|
| Fracture resistance | 120 N |
| Friability | 0% |
| Disintegration time | 5:25 (min:s) |
| Release | 20 min: 100% |

The coating was smooth, uniform, and homogeneous. The engraving was attractively reproduced, without smearing effects or bridging. No prolongation of the disintegration time or of active substance release as compared with the core was found. The fracture strength was 27 N higher than that of the core. In the course of 12 months' stability testing, no changes in the properties of the film coated tablets were found.

### Example 2

Coating Composition:

| | |
|---|---|
| 75:25 polyvinyl alcohol-polyethylene glycol 6000 | 40% |
| graft copolymer (degree of hydrolysis: 94 mol %) | |
| 6:4 vinylpyrrolidone-vinyl acetate copolymer | 30% |
| (copolyvidone) | |
| Talc | 20% |
| Titanium dioxide | 5% |
| Yellow iron oxide | 5% |

Preparation:

All of the constituents were mixed for 10 minutes in a Turbula mixer. This premix was stirred into water, using a paddle stirrer, so giving a spraying formulation having a solids content of 35%. Dissolution or dispersing was over after 13 minutes. The spraying suspension was of low viscosity and homogeneous.

The spraying suspension was applied in a horizontal drum coater (24″ Accela-Cota) to 5 kg of propranolol tablets:

Spraying Conditions:

| | |
|---|---|
| Incoming air temperature | 71° C. |
| Outgoing air temperature | 40° C. |
| Spraying rate | 55 g/min |
| Spraying pressure | 4 bar |
| Application rate | 543 g of spray dispersion, |
| | i.e., 190 g of solids |
| Spray time | 10 min |

Properties of Film Coated Tablets:

| | |
|---|---|
| Fracture resistance | 118 N |
| Friability | 0% |
| Disintegration time | 5:15 (min:s) |
| Release | 20 min: 100% |

The coating was smooth, uniform, and homogeneous. The engraving was attractively reproduced, without smearing effects or bridging. No prolongation of the disintegration time or of active substance release as compared with the core was found. The fracture strength was 25 N higher than that of the core. In the course of 12 months' stability testing, no changes in the properties of the film coated tablets were found.

### Example 3

Coating Composition:

| | |
|---|---|
| 75:25 polyvinyl alcohol-polyethylene glycol 6000 | 40% |
| graft copolymer (degree of hydrolysis: 94 mol %) | |
| Polyvinyl alcohol (degree of hydrolysis: 88 mol %, | 27% |
| viscosity: 4 mPas) | |
| Talc | 24% |
| Titanium dioxide | 7% |
| Indigotine lake | 2% |

Preparation:

A solution of polyvinyl alcohol-polyether graft copolymer and polyvinyl alcohol having a solids content of 30% was subjected to spray drying. This powder was mixed with talc, titanium dioxide, and indigotine lake in a Turbula mixer for 10 minutes to give a premix.

The spraying suspension was prepared by stirring the premix into water by means of a paddle stirrer, so giving a spraying formulation having a solids content of 30%. Dissolution or dispersing was over after 15 minutes. The spraying suspension was of low viscosity and homogeneous.

The spraying suspension was applied in a horizontal drum coater (24″ Accela-Cota) to 5 kg of caffeine tablets of the following composition:

| | |
|---|---|
| Caffeine | 50 mg |
| Ludipress ® (BASF AG) | 229 mg |
| Microcrystalline cellulose¹⁾ | 40 mg |
| Crospovidone | 10 mg |
| Magnesium stearate | 1 mg |
| Total weight | 330 mg |

Diameter: 9 mm, domed
¹⁾ Average particle size: 100 μm

Spraying Conditions:

| | |
|---|---|
| Incoming air temperature | 70° C. |
| Outgoing air temperature | 41° C. |
| Spraying rate | 48 g/min |
| Spraying pressure | 4.5 bar |
| Application rate | 520 g of spray dispersion, |
| | i.e., 150 g of solids |
| Spray time | 11 min |

Properties of Film Coated Tablets:

| | |
|---|---|
| Fracture resistance | 131 N |
| Friability | 0% |
| Disintegration time | 0:48 (min:s) |
| Release | 20 min: 100% |

The coating was smooth, uniform, and homogeneous. The engraving was attractively reproduced, without smearing effects or bridging. No prolongation of the disintegration time or of active substance release as compared with the core was found. The fracture strength was 24 N higher than that of the core. In the course of 12 months' stability testing, no changes in the properties of the film coated tablets were found.

### Example 4

Coating Composition

| | |
|---|---|
| 75:25 polyvinyl alcohol-polyethylene glycol 6000 | 60% |
| graft copolymer (degree of hydrolysis: 94 mol %) | |
| Polyvinyl alcohol (degree of hydrolysis: 88 mol %, | 40% |
| viscosity: 4 mPas) | |

Preparation

The spray dried powder of polyvinyl alcohol-polyether graft copolymer and polyvinyl alcohol from example 3 was dissolved in water using a paddle stirrer so as to give a solids concentration of 24%. Dissolution was over after 15 minutes. This solution was sprayed onto soft gelatin capsules in a horizontal drum coater (24″ Accela-Cota) at an incoming air temperature of 60° C.

The soft gelatin capsules had a smooth, uniform, extremely flexible, quick dissolving coating which also withstood mechanical loads such as pressure and tension. No changes occurred during 12 months' storage.

### Example 5

Coating Composition:

| | |
|---|---|
| 80:20 polyvinyl alcohol-methylpolyethylene glycol 1500 | 55% |
| graft copolymer (degree of hydrolysis: 96 mol %) | |
| Mannitol | 20% |
| Talc | 15% |
| Titanium dioxide | 6% |
| Red iron oxide | 3.5% |
| Polydimethylsiloxane (dimethicone) | 0.5% |

Preparation:

All of the constituents were granulated in a Glatt fluidized bed granulator at an incoming air temperature of 70° C. by spraying in 30% (based on the overall mixture) of water.

These premix granules were stirred into water using a paddle stirrer to produce a spraying suspension having a solids content of 30%. After just 10 minutes the preparation was fully redispersed and ready for use. Application to the tablets took place as in example 1.

### Example 6

Coating Composition:

| | |
|---|---|
| 70:30 polyvinyl alcohol-polypropylene glycol graft | 55% |
| copolymer (degree of hydrolysis: 97 mol %) | |
| Lactose | 28.5% |
| Talc | 10% |
| Titanium dioxide | 5% |
| Quinoline yellow lake | 1.5% |

Preparation:

All of the constituents were sprayed in a Stephan mixer with 15% (based on the overall mixture) of water, passed through a sieve with a mesh size of 1.0 mm, and dried.

These premix granules were stirred into water using a paddle stirrer to produce a spraying suspension having a solids content of 35%. After just 10 minutes the preparation was fully redispersed and ready for use. Application to the tablets took place as in example 2.

### Example 7

Coating Composition:

| | |
|---|---|
| 75:25 polyvinyl alcohol-polyethylene glycol 4000 | 55% |
| graft copolymer | |
| (degree of hydrolysis: 96 mol %) | |
| Microcrystalline cellulose | 30% |
| average particle size 20 μm | |
| Talc | 6% |
| Titanium dioxide | 5% |
| Red iron oxide | 3.7% |
| Sodium lauryl sulfate | 0.3% |

Preparation:

All constituents were mixed in a Turbula mixer for 10 minutes.

This premix was stirred into water using a paddle stirrer to produce a spraying suspension having a solids content of 40%. After just 16 minutes the preparation was fully redispersed and ready for use. Application to the tablets took place as in example 3.

### Example 8

Coating Composition:

| | |
|---|---|
| 75:25 polyvinyl alcohol-polyethylene glycol 6000 | 71% |
| graft copolymer | |
| (degree of hydrolysis: 96 mol %) | |
| Highly disperse silica (Aerosil 200) | 10% |
| Talc | 10% |
| Titanium dioxide | 6% |
| Quinoline yellow lake | 3% |

Preparation:

All constituents were mixed in a Turbula mixer for 10 minutes.

This premix was stirred into water using a paddle stirrer to produce a spraying suspension having a solids content of 25%. After just 10 minutes the preparation was fully redispersed and ready for use. Application to the tablets took place as in example 3.

### Example 9

Coating Composition:

| | |
|---|---|
| 85:15 polyvinyl alcohol-polyethylene glycol 6000 | 60% |
| graft copolymer | |
| (degree of hydrolysis: 92 mol %) | |
| Maltodextrin DE value 17 | 20% |
| Titanium dioxide | 12% |
| Red iron oxide | 7.5% |
| Sodium dioctyl sulfosuccinate | 0.5% |

Preparation:

All constituents were mixed in a Turbula mixer for 10 minutes, compacted on a roll compactor (Bepex), and pressed through a sieve with a mesh size of 1.5 mm.

This premix was stirred into water using a paddle stirrer to produce a spraying suspension having a solids content of 25%. After just 11 minutes the preparation was fully redispersed and example 1.

### Example 10

Coating Composition:

| | |
|---|---|
| 75:25 polyvinyl alcohol-polyethylene glycol 6000 | 62% |
| graft copolymer | |
| (degree of hydrolysis: 94 mol %) | |
| Chitosan hydrochloride | 8% |
| Talc | 15% |
| Titanium dioxide | 13% |
| Dry betacarotene powder | 2% |

Preparation:

All constituents were mixed in a Turbula mixer for 10 minutes.

This premix was stirred into water using a paddle stirrer to produce a spraying suspension having a solids content of 25%. After just 13 minutes the preparation was fully redispersed and ready for use. Application to the tablets took place as in example 1.

### Example 11

Coating Composition:

| | |
|---|---|
| 75:25 polyvinyl alcohol-polyethylene glycol 1500 | 62% |
| graft copolymer | |
| (degree of hydrolysis: 96 mol %) | |
| Urea | 15% |
| Calcium hydrogen phosphate | 15% |
| Titanium dioxide | 5% |
| Yellow orange lake | 3% |

Preparation:

All constituents were mixed in a Turbula mixer for 10 minutes.

This premix was stirred into water using a paddle stirrer to produce a spraying suspension having a solids content of 27%. After just 12 minutes the preparation was fully redispersed and example 1.

### Example 12

Coating Composition:

| | |
|---|---|
| 75:25 polyvinyl alcohol-polyethylene glycol 6000 | 62% |
| graft copolymer | |
| (degree of hydrolysis: 94 mol %) | |
| Isomalt | 15% |
| Calcium hydrogen phosphate | 15% |
| Talc | 10% |
| Titanium dioxide | 5% |
| Patent blue | 3% |

Preparation:

All constituents were mixed in a Turbula mixer for 10 minutes.

This premix was stirred into water using a paddle stirrer to produce a spraying suspension having a solids content of 25%. After just 11 minutes the preparation was fully redispersed and ready for use. Application to the tablets took place as in example 1.

### Example 13

Coating Composition:

| | |
|---|---|
| 75:25 polyvinyl alcohol-polyethylene glycol 6000 | 62% |
| graft copolymer | |
| (degree of hydrolysis: 94 mol %) | |
| Carrageenan | 15% |
| Talc | 15% |
| Titanium dioxide | 5% |
| Quinoline yellow lake | 3% |

Preparation:

All constituents were mixed in a Turbula mixer for 10 minutes.

This premix was stirred into water using a paddle stirrer to produce a spraying suspension having a solids content of 24%. After just 15 minutes the preparation was fully redispersed and example 3.

### Example 14

Coating Composition:

| | |
|---|---|
| 80:20 polyvinyl alcohol-polyethylene glycol 4000 | 55% |
| graft copolymer | |
| (degree of hydrolysis: 96 mol %) | |
| Polyethylene oxide-polypropylene oxide block | 12% |
| copolymer | |
| Poloxamer 188 | |
| Talc | 20% |
| Titanium dioxide | 10% |
| Azorubine lake | 3% |

Preparation:

All constituents were mixed in a Turbula mixer for 10 minutes.

This premix was stirred into water using a paddle stirrer to produce a spraying suspension having a solids content of 28% by weight. After just 13 minutes the preparation was fully redispersed and ready for use. Application to the tablets took place as in example 3.

### Example 15

Coating Composition:

| | |
|---|---|
| 75:25 polyvinyl alcohol-polyethylene glycol 6000 | 40% |
| graft copolymer | |
| (degree of hydrolysis: 92 mol %) | |
| 6:4 vinylpyrrolidone-vinyl acetate copolymer | 30% |
| Microcrystalline cellulose, average | 20% |
| particle size 20 μm | |
| Titanium dioxide | 5% |
| Brown iron oxide | 5% |

Preparation:

All constituents were mixed in a Turbula mixer for 10 minutes.

This premix was stirred into water using a paddle stirrer to produce a spraying suspension having a solids content of 32%. After just 13 minutes the preparation was fully redispersed and ready for use. Application to the tablets took place as in example 1.

### Example 16

Coating Composition:

| | |
|---|---|
| 75:25 polyvinyl alcohol-polyethylene glycol 6000 | 40% |
| graft copolymer | |
| (degree of hydrolysis: 94 mol %) | |
| 6:4 vinylpyrrolidone-vinyl acetate copolymer | 15% |
| (copolyvidone) | |
| Microcrystalline cellulose, average | 10% |
| particle size 20 μm | |
| Carrageenan | 5% |
| Talc | 10% |
| Calcium hydrogen phosphate | 10% |
| Titanium dioxide | 5% |
| Yellow iron oxide | 5% |

Preparation:

All constituents were mixed in a Turbula mixer for 10 minutes.

This premix was stirred into water using a paddle stirrer to produce a spraying suspension having a solids content of 37%. After just 15 minutes the preparation was fully redispersed and ready for use. Application to the tablets took place as in example 1.

### Example 17

Coating Composition:

| | |
|---|---|
| 75:25 polyvinyl alcohol-polyethylene glycol 6000 | 51% |
| graft copolymer | |
| (degree of hydrolysis: 94 mol %) | |
| 6:4 vinylpyrrolidone-vinyl acetate copolymer | 15% |
| (copolyvidone) | |
| Microcrystalline cellulose, average | 10% |
| particle size 20 μm | |
| Polyethylene oxide-polypropylene oxide block | 5% |
| copolymer | |
| Poloxamer 407 | |
| Highly disperse silica, specific surface area | 4% |
| 200 m²/g | |
| Talc | 8% |
| Titanium dioxide | 5% |
| Red iron oxide | 3% |

Preparation:

All constituents were mixed in a Turbula mixer for 10 minutes.

This premix was stirred into water using a paddle stirrer to produce a spraying suspension having a solids content of 25%. After just 8 minutes the preparation was fully redispersed and ready for use. Application to the tablets took place as in example 3.

### Example 18

Coating Composition:

| | |
|---|---|
| 75:25 polyvinyl alcohol-polyethylene glycol 6000 | 30% |
| graft copolymer | |
| (degree of hydrolysis: 94 mol %) | |
| 6:4 vinylpyrrolidone-vinyl acetate copolymer | 10% |
| (copolyvidone) | |
| Microcrystalline cellulose, average | 10% |
| particle size 20 μm | |
| Polyethylene oxide-polypropylene oxide block | 4% |
| copolymer | |
| Poloxamer 407 | |
| Highly disperse silica, specific | 4% |
| surface area 200 m²/g | |
| Talc | 40% |
| Patent blue | 1.5% |
| Sodium lauryl sulfate | 0.5 |

Preparation:

All constituents were mixed in a Turbula mixer for 10 minutes.

This premix was stirred into water using a paddle stirrer to produce a spraying suspension having a solids content of 25%. After just 7 minutes the preparation was fully redispersed and example 3.

### Example 19

Coating Composition:

| | |
|---|---|
| 75:25 polyvinyl alcohol-polyethylene glycol 6000 | 30% |
| graft copolymer | |
| (degree of hydrolysis: 94 mol %) | |
| Polyvinyl alcohol (degree of hydrolysis: 88 mol %, | 40% |
| viscosity: 4 mPas) | |
| Microcrystalline cellulose, average | 10% |
| particle size 20 μm | |
| Polyethylene oxide-polypropylene oxide block | 5% |
| copolymer | |
| Poloxamer 407 | |
| Highly disperse silica, specific surface area | 5% |
| 200 m²/g | |
| Talc | 5% |
| Titanium dioxide | 5% |

Preparation:

All constituents were spray dried from 25% solution.

This premix was stirred into water using a paddle stirrer to produce a spraying suspension having a solids content of 25%. After just 10 minutes the preparation was fully redispersed and ready for use. Application to the tablets took place as in example 1.

In order to apply colored coatings, any desired dyes may be added to the spraying suspension.

### Example 20

Coating Composition:

| | |
|---|---|
| 75:25 polyvinyl alcohol-polyethylene glycol 6000 | 40% |
| graft copolymer | |
| (degree of hydrolysis: 94 mol %) | |
| Polyvinyl alcohol (degree of hydrolysis: 88 mol %, | 30% |
| viscosity: 4 mPas) | |
| Microcrystalline cellulose, average particle | 10% |
| size 20 μm | |
| Mannitol | 5% |
| Highly disperse silica, specific surface area | 5% |
| 200 m²/g | |
| Talc | 5% |
| Titanium dioxide | 5% |

Preparation:

A spray dried powder of polyvinyl alcohol-polyethylene glycol 6000 (75:25) graft copolymer and polyvinyl alcohol (degree of hydrolysis: 88 mol %, viscosity: 4 mPas) in a ratio of 4:3 was mixed with the other constituents in a Turbula mixer for 10 minutes.

This premix was stirred into water using a paddle stirrer to produce a spraying suspension having a solids content of 25%. After just 11 minutes the preparation was fully redispersed and ready for use. Application to the tablets took place as in example 1.

In order to apply colored coatings, any desired dyes may be added to the spraying suspension.

### Example 21

Coating Composition:

| | |
|---|---|
| 75:25 polyvinyl alcohol-polyethylene glycol 6000 | 55% |
| graft copolymer | |
| (degree of hydrolysis: 96 mol %) | |
| Hydroxypropylmethylcellulose, substitution | 12% |
| type 2910, viscosity of 2% strength by weight | |
| aqueous solution: 3 mPas | |
| Talc | 20% |
| Titanium dioxide | 10% |
| Azorubine lake | 3% |

Preparation:

All constituents were mixed in a Turbula mixer for 10 minutes.

This premix was stirred into water using a paddle stirrer to produce a spraying suspension having a solids content of 28%. After just 12 minutes the preparation was fully redispersed and example 3.

### Example 22

Coating Composition:

| | |
|---|---|
| 75:25 polyvinyl alcohol-polyethylene glycol 6000 | 50% |
| graft copolymer | |
| (degree of hydrolysis: 94 mol %) | |
| 1:2:1 butyl methacrylate-2-dimethylaminoethyl | 10% |
| methacrylate-methyl methacrylate copolymer | |
| Citric acid | 2.5% |
| Microcrystalline cellulose, average particle size | 20% |
| 20 μm | |
| Sodium lauryl sulfate | 0.5% |
| Titanium dioxide | 5% |
| Talc | 7% |
| Brown iron oxide | 5% |

Preparation:

All constituents were mixed in a Turbula mixer for 10 minutes.

This premix was stirred into water using a paddle stirrer to produce a spraying suspension having a solids content of 28%. After just 11 minutes the preparation was fully redispersed and ready for use. Application to the tablets took place as in example 1.

### Example 23

Coating Composition:

| | |
|---|---|
| 75:25 polyvinyl alcohol-polyethylene glycol 6000 | 50% |
| graft copolymer | |
| (degree of hydrolysis: 96 mol %) | |
| Hydroxypropylcellulose, degree of substitution | 15% |
| 3.4-4.1, viscosity of 10% strength by weight aqueous | |
| solution: 300-600 mPas | |
| Talc | 22% |
| Titanium dioxide | 10% |
| Quinoline yellow lake | 3% |

Preparation:

All constituents were mixed in a Turbula mixer for 10 minutes.

This premix was stirred into water using a paddle stirrer to produce a spraying suspension having a solids content of 28%. After just 12 minutes the preparation was fully redispersed and ready for use. Application to the tablets took place as in example 3.

1. A quick dissolving film coating composition for coating solid substrates, composed of
a) 10-90% by weight of a polyvinyl alcohol-polyether graft copolymer (component A),
b) 5-80% by weight of at least one further component containing at least one functional group selected from the group consisting of hydroxyl, amide and ester functions (component B), and
c) 0-70% by weight of further customary coating constituents (components C).

2. A composition as claimed in claim 1, wherein component B is a polymer.

3. A composition as claimed in claim 1, wherein component B is a sugar, a sugar alcohol, or a derivative thereof.

4. A composition as claimed in claim 1, wherein component B is a highly disperse silica having a specific surface area ≧100 m²/g.

5. A composition as claimed in claim 1, wherein component B is a polymer selected from the group consisting of polyvinyl alcohols, polysaccharides, celluloses, starches, gelatin, polyvinylpyrrolidones, vinylpyrrolidone-vinyl acetate copolymers, vinylpyrrolidone-methacrylate copolymers, vinylpyrrolidone-acrylate copolymers, (meth)acrylate copolymers, hydroxyalkyl (meth)acrylate copolymers, polyvinyl acetates, polylactides, polyethylene glycols, polypropylene glycols, polyethylene glycol-polypropylene glycol block copolymers, and derivatives thereof.

6. A composition as claimed in claim 1, wherein component B is a compound selected from the group consisting of lactose, sucrose, glucose, xylose, mannitol, sorbitol, xylitol and isomalt.

7. A composition as claimed in claim 1, wherein component B is a polyvinyl alcohol having a degree of hydrolysis of between 80 and 99 mol %.

8. A composition as claimed in claim 1, wherein component B is selected from the group consisting of hydroxypropylmethylcellulose, hydroxypropylcellulose, hydroxyethylcellulose, hydroxyethylmethylcellulose, methylcellulose, ethylcellulose, carboxymethylcellulose, cellulose, and microcrystalline cellulose.

9. A composition as claimed in claim 1, wherein component B is selected from the group consisting of alginates, including propylene glycol alginates, carrageenans, pectins, guar, tara, xanthans, gum arabic, chitosans, and salts thereof.

10. A composition as claimed in claim 1, wherein component B is selected from the group consisting of N-vinylpyrrolidone homopolymers, crosslinked polyvinylpyrrolidones, polyvinyl acetate, and N-vinylpyrrolidone-vinyl acetate copolymers.

11. A composition as claimed in claim 1, wherein component B comprises vinylpyrrolidone-acrylate copolymers or vinylpyrrolidone-methacrylate copolymers.

12. A composition as claimed in claim 1, wherein component B comprises (meth)acrylate copolymers or hydroxyalkyl (meth)acrylate copolymers.

13. A composition as claimed in claim 1, wherein component B comprises a 1:2:1 butyl methacrylate-2-dimethylaminoethyl methacrylate-methyl methacrylate copolymer, a methacrylic acid-methyl methacrylate copolymer, a 1:1 methacrylic acid-ethyl acrylate copolymer or a salt thereof.

14. A composition as claimed in claim 1, wherein component B comprises starch, starch derivatives, starch hydrolyzates, amylose, cyclodextrins, maltodextrins, glucose syrups, dextrans, inulin, polydextrose or polyfructose.

15. A composition as claimed in claim 1, of claims 1 to 14, wherein component B comprises lactose, glucose, xylose or sucrose.

16. A composition as claimed in claim 1, wherein component B comprises isomalt.

17. A composition as claimed in claim 1, wherein component B comprises mannitol, sorbitol or xylitol.

18. A composition as claimed in claim 1, wherein component B comprises urea.

19. A composition as claimed in claim 1, wherein component B comprises a highly disperse silica having a specific surface area ≧100 m²/g.

20. A composition as claimed in claim 1, wherein components C comprise dyes, lakes, pigments, detackifiers, fillers, shine enhancers, wetting agents, surfactants, foam preventatives, protective colloids, buffer substances, pH regulators, and plasticizers.

21. A process for producing coated substrates, which comprises stirring a film coating composition as claimed in claim 1 into water and applying it to the substrate by means of an appropriate spraying means, the film coating being dried gradually by supplying heated air.

22. A process as claimed in claim 21, wherein before adding it to water said composition is either dry mixed or compacted or granulated and is introduced as a premix into water.

23. A process as claimed in claim 21, wherein components A and B and also components C minus the coloring components are dry mixed or compacted or granulated and that preparation is stirred into water before or together with the coloring components.

24. A process as claimed in claim 21, wherein a mixture of components A and B is subjected from aqueous solution to spray drying, fluidized bed drying or roller drying and this powder, with components C, is stirred into water.

25. A process as claimed in claim 21, wherein a mixture of components A and B is subjected from aqueous solution to spray drying, fluidized bed drying or roller drying and this powder is granulated or compacted or mixed with components C and is stirred into water as such a mixture.

26. A process as claimed in claim 21, wherein components A and B and also components C minus the coloring components are subjected from aqueous solution to spray drying, fluidized bed drying or roller drying and the resultant powder, where appropriate with the coloring component, is stirred into water.

27. A solid substrate coated with a film coating of claim 1.

28. A substrate as claimed in claim 26, selected from pharmaceutical, cosmetic, and agrochemical product forms, seed, dietary supplements, and foods.
